(19) United States
(12) Patent Application Publication
(10) Pub. No.: US 2015/0039478 A1
(43) Pub. Date: Feb. 5, 2015

(54) IN-MEMORY-DATABASE-DRIVEN BUSINESS CONSOLIDATION SYSTEM REPORTING

(71) Applicants: Jens Heumann, Hassloch (DE); Wallace Yao, Shanghai (CN); Richard Gu, Shanghai (CN); Javy Tao, Shanghai (CN)

(72) Inventors: Jens Heumann, Hassloch (DE); Wallace Yao, Shanghai (CN); Richard Gu, Shanghai (CN); Javy Tao, Shanghai (CN)

(73) Assignee: SAP AG, Walldorf (DE)

(21) Appl. No.: 13/960,457

(22) Filed: Aug. 6, 2013

(30) Foreign Application Priority Data
Jul. 31, 2013 (CN) 201310329075.X

(51) Int. Cl. G06Q 40/00

(52) U.S. Cl. CPC G06Q 40/12
USPC 705/30

(57) ABSTRACT

The present disclosure describes methods, systems, and computer program products for providing enhanced business consolidation system reporting functionality according to an implementation. One computer-implemented method includes retrieving financial journal entry data from a total record for consolidation into a consolidated financial report, the financial journal entry data classified as single company closing records, inter-company elimination records, and group-dependent elimination records, processing the single company closing records resulting in single company closing records result data, processing the inter-company elimination records resulting in inter-company elimination records result data, processing the group-dependent elimination records resulting in group-dependent elimination records result data, performing, by operation of a computer, a union of the single company closing records result data, the inter-company elimination records result data, and the group-dependent elimination records result data to generate consolidated financial report data, and generating a consolidated financial report based, at least in part, on the consolidated financial report data.

### BACKGROUND

A business group can be made up of many separate business organizations. The business group is often required by law to provide a consolidated financial report (CFR) according to internal financial reporting standard (IFRS) and/or other standards, both domestic and international. The business group is not required, nor does it wish, to disclose internal business transactions between the separate business organizations that make up the business group. A business consolidation system (BCS) reporting software application is often used by the business group to generate the consolidated financial report and to eliminate internal transactions of the separate business organizations from source business data. The BCS reporting software application logic often suffers from poor time performance and/or additional storage requirement limitations. The time performance and additional storage requirement limitations can introduce report generation delay and additional storage cost for the generation of the CFR and therefore the business group's total cost of ownership for the BCS reporting software application.

### SUMMARY

The present disclosure relates to computer-implemented methods, computer-readable media, and computer systems for providing enhanced business consolidation system reporting functionality. One computer-implemented method includes retrieving financial journal entry data from a total record for consolidation into a consolidated financial report, the financial journal entry data classified as single company closing records, inter-company elimination records, and group-dependent elimination records, processing the single company closing records resulting in single company closing records result data, processing the inter-company elimination records resulting in inter-company elimination records result data, processing the group-dependent elimination records resulting in group-dependent elimination records result data, performing, by operation of a computer, a union of the single company closing records result data, the inter-company elimination records result data, and the group-dependent elimination records result data to generate consolidated financial report data, and generating a consolidated financial report based, at least in part, on the consolidated financial report data

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein processing the posting level 10 data comprises, joining the total record with a factor table for a consolidation unit by the consolidation unit.

A second aspect, combinable with any of the previous aspects, wherein processing the posting level 20 data comprises: joining the total record with a factor table of a consolidation unit by the consolidation unit to generate a first result, joining the first result with the factor table of a consolidation group by a partner unit, checking if the consolidation group and the partner group are the same to generate a check result, and filtering on the check result.

A third aspect, combinable with any of the previous aspects, wherein processing the posting level 30 data comprises joining the total record with a factor table of a consolidation group by a consolidation unit and the consolidation group.

A fourth aspect, combinable with any of the previous aspects, wherein: for each posting level, a factor table for a company is joined with the total record to form a first result, and for each posting level, a factor table for a profit center is joined with the first result to form a second result.

A fifth aspect, combinable with any of the previous aspects, wherein processing the posting level 20 comprises: joining factor tables for consolidation units to form a first result; and joining the first result with the posting level 20 data of the total record.

A sixth aspect, combinable with any of the previous aspects, wherein processing the posting level 20 comprises: joining factor tables for consolidation units to form a first result, and joining the first result with the posting level 20 data of the total record.

A seventh aspect, combinable with any of the previous aspects, wherein data from the total record is aggregated according to required fields prior to processing at each posting level.

The subject matter described in this specification can be implemented in particular implementations so as to realize one or more of the following advantages. First, the most time consuming portion of business consolidation system (BCS) reporting logic is moved into a calculation view of an in-memory database. As a result, BCS operations are performed in real- or substantially-near real-time. Second, the calculation view is generated dynamically based on a query and the generation is transparent to end-users. Third, the model of the calculation view is determined by a transactional cube (total record) for data of interest (e.g., a factor table is used to determine/“filter” data of interest from the total record and the appropriate calculation view model chosen based on the data) and the reporting mode associated with the query. In other words, although the calculation view is generated dynamically during runtime of the query, it is done only once with the given transactional cube and reporting mode. Fourth, hierarchy analysis data for the business group is stored into in-memory database tables which allows the calculation view to interpret transactional data according to the analyzed hierarchy structure. Fifth, reading reporting-logic-resultant data from the in-memory database calculation view is supported by a set of API's. Sixth, a separate reporting cube is not needed to store a pre-calculated result for reporting purposes. As a result, total cost of ownership is reduced for BCS operations. Seventh, very little change is required to existing queries to source data. Eighth, reporting in the manner described in the disclosure will always return current data. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing enhanced business consolidation system (BCS) reporting functionality according to an implementation.

FIG. 2 is a block diagram illustrating an example solution architecture for providing enhanced BCS reporting functionality according to an implementation.

FIG. 3 is a flow chart illustrating a method for generating a calculation view providing enhanced business consolidation system reporting functionality according to an implementation.

FIGS. 4A-4C illustrate example method enhancements to portions of the method of FIG. 3 according to an implementation.

Like reference numbers and designations in the various drawings indicate like elements.

### DETAILED DESCRIPTION

This disclosure generally describes computer-implemented methods, computer-program products, and systems for providing enhanced business consolidation system (BCS) reporting functionality. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

A business group can be made up of many separate business organizations. The reporting, analysis, and interpretation of business data is of central importance to the business group in guaranteeing its competitive edge, optimizing processes, and enabling it to react quickly and in line with one or more markets. Relevant business information from various data sources can be integrated, transformed, consolidated, cleaned-up, extracted, analyzed, interpreted, and stored using a business data “warehouse” (BW).

The business group is often required by law to provide a consolidated financial report (CFR) according to internal financial reporting standard (IFRS) and/or other standards, both domestic and international. Business consolidation can be used to determine the resources of a business group, claims by others to the resources, and changes to the resources as well as internal and external reporting. For example, consolidation can be based on business organizations/consolidation units, such as companies, plants, business areas, profit centers, and cost centers (i.e., the smallest element in a corporate structure that is used as a basis for consolidation). Matrix organizations can also be portrayed using a combination of companies and profit centers. Financial data reported by individual consolidation units can be standardized to adhere to the accounting and valuation standards of the business group. Standardized financial data can be translated from various local currencies into business group currencies. For external consolidated financial reporting, the business group is not required, nor does it wish, to disclose internal business transactions between the separate business organizations that make up the business group. A BCS reporting application is often used to eliminate internal-transactions/business-group-internal relationships (for example, from inter-unit trade and services) from source business data in the BW and to generate the required CFRs.

In consolidated reporting, all records should appear in certain levels of groups, although not all data in the system is group dependent (e.g., the data may not have associated group information). An example is reported financial data from a subsidiary and the fact that a company hierarchy can vary from time to time and a company can be transferred to a different group (sub-group) in a different time period. One task of the BCS reporting software application logic is to update data with correct group information according to a hierarchy structure associated with a given time period factor.

Existing BCS reporting software application logic often suffers from poor time performance and/or additional storage requirement limitations. The time performance and additional storage requirement limitations can introduce report generation delay and additional storage cost for the generation of the required CFRs and therefore the business group's total cost of ownership for the BCS reporting software application and BW. It would be advantageous to enhance BCS reporting functionality with respect to both time performance and reduction in storage requirements.

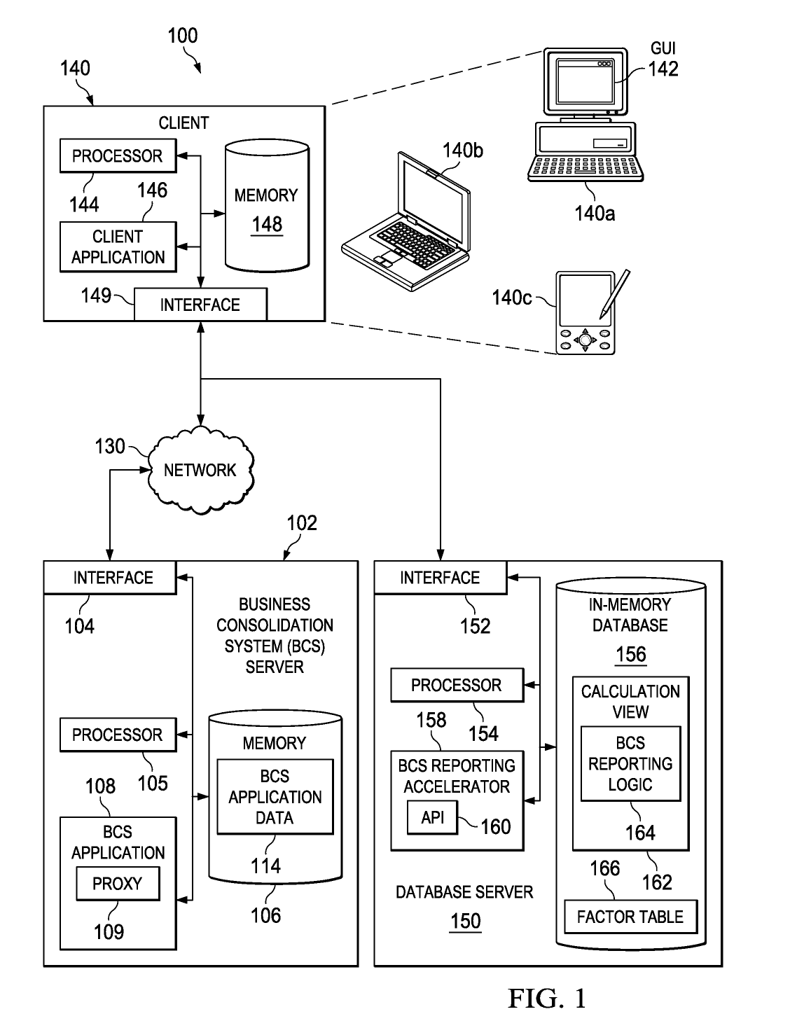

FIG. 1 is a block diagram illustrating an example distributed computing system (EDCS) 100 for providing enhanced business consolidation system reporting functionality according to an implementation. The illustrated EDCS 100 includes or is communicably coupled with one or more business consolidation system (BCS) servers 102, one or more clients 140, and one or more database servers 150 that communicate across a network 130. In other implementations, other appropriate computing components can be coupled to the EDCS 100. In some implementations, the EDCS 100 can be a cloud-computing environment.

At a high level, the BCS server 102 is an electronic computing device within the EDCS 100 that is operable to receive, transmit, process, store, or manage data and information. According to some implementations, the BCS server 102 may be, include, and/or be communicably coupled with an e-mail server, a web server, a caching server, a streaming data server, and/or other suitable server. The BCS server 102 may operate in a cloud-based computing environment.

In general, the BCS server 102 is a server that stores and/or executes one or more BCS applications 108 (described below) responsive to requests/responses sent by other BCS servers 102, clients 140 (e.g., from a client application (described below)), database servers 150 e.g., from a BCS reporting accelerator 158 (described below)), and/or other components (whether illustrated or not) within and communicably coupled to the illustrated EDCS 100. In some implementations, BCS server 102 can be accessed directly or using the network 130 to perform programmed tasks or operations of a particular BCS application 108 and/or associated component (e.g., proxy 109). Requests/responses may also be sent to the BCS server 102 from internal users, external or third-parties, other automated applications, as well as any other appropriate entities, individuals, systems, or computers (whether illustrated or not).

In some implementations, any and/or all components of the BCS server 102, both hardware and/or software, may interface with each other and/or the interface using an application programming interface (API) and/or a service layer (neither illustrated). The API may include specifications for routines, data structures, and object classes. The API may be either computer-language independent or dependent and refer to a complete interface, a single function, or even a set of APIs. The service layer provides software services to the EDCS 100. The functionality of the BCS server 102 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. The API and/or service layer can be wholly or partial integral or stand alone in relation to the BCS server 102 or components of the EDCS 100. Moreover, any or all parts of the API and/or the service layer may be implemented as child or sub-modules of another software module, enterprise application, or hardware module.

The BCS server 102 includes an interface 104. Although illustrated as a single interface 104 in FIG. 1, two or more interfaces 104 may be used according to particular needs, desires, or particular implementations of the EDCS 100. The interface 104 is used by the BCS server 102 for communicating with other systems in a distributed environment—including within the EDCS 100—connected to the network 130; for example, the client 140, database server 150, other BCS servers 102, and/or other systems (whether illustrated or not) that may be communicably coupled to the network 130. Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The BCS server 102 includes a processor 105. Although illustrated as a single processor 105 in FIG. 1, two or more processors may be used according to particular needs, desires, or particular implementations of the EDCS 100. The processor 105 executes instructions and manipulates data to perform the operations of the BCS server 102 and/or functionality required to provide enhanced business consolidation system reporting functionality.

The BCS server 102 also includes a memory 106 that holds data for the BCS server 102, client 140, database server 150, and/or other components of the EDCS 100 (whether illustrated or not). Although illustrated as a single memory 106 in FIG. 1, two or more memories may be used according to particular needs, desires, or particular implementations of the EDCS 100. While memory 106 is illustrated as an integral component of the BCS server 102, in alternative implementations, memory 106 can be external to the BCS server 102 and/or the EDCS 100. In some implementations, the memory 106 includes one or more instances of BCS application data 114.

The BCS application 108 is any type of application that, at a high level, allows the client 140, database server 150, and/or other component(s) of the EDCS 100 to request, view, add, edit, delete, manage, and/or consume content obtained from/by the BCS server 102 and/or database server 150 in response to a received request/responses. The BCS application 108 provides advanced and powerful consolidation logic; supporting multiple business consolidation scenarios, including various ways of data collection, currency translation, intercompany reconciliation and elimination, consolidation of investment, elimination of unrealized profit in inventory as well as fixed assets, restatement of consolidation logic for business groups with common control requirements, and the like. Business consolidation functionality includes determining the resources of a business group, claims by others to the resources, changes to the resources, translation/standardization of financial data, as well as providing internal and external reporting (including consolidated financial reporting). In some implementations, the most important function of the BCS application 108 is to eliminate/convert internal transactions for companies belonging to the same group (refer below to FIG. 3, “B. inter-company elimination records” for additional details). The BCS application 108 can also interface with other BCS applications 108 and/or other suitable components of the EDCS 100 (for example the database server 150) to wholly or partially complete a particular task such as enhanced business consolidation system reporting functionality.

In some implementations, the BCS application 108 can also be associated with BCS application data 114, including objects and data, user profiles, processes, content provider locations, addresses, data storage locations/specifications, content lists, access requirements, and/or any other suitable data associated with a BCS application 108. The BCS application data 114 can be represented by any type of suitable data structure(s) and in any suitable format(s). For example, the BCS application data 114 could be an executable module, spreadsheet, database, flat file, binary file, multi-part file, linked list, and/or the like.

The BCS application 108 is also associated with a proxy 109. The proxy 109 can be any type of application that interfaces with the database server 150 (particularly the BCS reporting accelerator 158 (described below)) to provide access to functionality not directly provided by the BCS application 108. For example, the proxy 109 can provide the BCS application 108 access to the BCS reporting logic 164 (described below) associated with the in-memory database 156 using the BCS reporting accelerator 158/API 160. In this example, the BCS application 108 can generate a request that is transmitted by proxy 109 to the BW (here represented by the BCS reporting accelerator 158 using API 160). The BCS application 108 generates one or more calculation views 162 using the BCS reporting accelerator 158/API 160 and reads data from the one or more calculation views 162. In addition, the BCS reporting accelerator 158 can query the BCS reporting logic 164 as part of calculation view 162 to perform a requested calculation.

Once a particular BCS application 108 is launched, a client 140, other BCS server 102, and/or database server 150 may interactively process a task, event, or other information associated with the BCS application 108. Additionally, a particular BCS application 108 may operate in response to and in connection with at least one request received from other BCS applications 108, including BCS applications 108 or other components (e.g., software and/or hardware modules) associated with another BCS server 102. In some implementations, the BCS application 108 can be and/or include a web browser. In some implementations, each BCS application 108 can represent a network-based application accessed and executed using the network 130 (e.g., through the Internet, or using at least one cloud-based service associated with the BCS application 108). For example, a portion of a particular BCS application 108 may be a web service associated with the BCS application 108 that is remotely called, while another portion of the BCS application 108 may be an interface object or agent bundled for processing at a remote client 140. Moreover, any or all of a particular BCS application 108 may be a child or sub-module of another software module without departing from the scope of this disclosure. Still further, portions of the particular BCS application 108 may be executed or accessed by a user working directly at the BCS server 102, as well as remotely at a corresponding client 140 and/or database server 150. In some implementations, the BCS server 102 or any suitable component of BCS server 102 or the EDCS 100 can execute the BCS application 108.

The client 140 (e.g., 140a-140c) may be any computing device operable to connect to or communicate with at least the BCS server 102 and/or the database server 150 using the network 130. In some implementations, the client 140 can communicate directly with the BCS server 102 and/or the database server 150 or indirectly through another component of the EDCS 100 (whether illustrated or not). In general, the client 140 comprises an electronic computing device operable to receive, transmit, process, and store any appropriate data associated with the EDCS 100. Typically the client 140 will process and/or respond (both automatically and/or by manual user interaction) to requests and/or responses generated by the BCS server 102 and/or the database server 150. The client 140 can also initiate requests to the BCS server 102 and/or database server 150. The client 140 typically includes a client application 146, processor 144, a memory 148, and/or an interface 149.

The client application 146 is any type of application that allows the client 140 to navigate to/from, request, view, edit, delete, and or manipulate content on the client 140, for example using a client application 146 that is WINDOWS-, LINUX-, HTML 5-, IOS-, and/or ANDROID-based. In some implementations, the client application 146 can be and/or include a web browser. In some implementations, the client application 146 can be a dedicated to one or more particular task(s), for example a BW application providing access to BCS application functionality, such as generation of CFRs.

In some implementations, the client-application 146 can use parameters, metadata, and/or other information received at launch from the client 140, BCS server 102, database server 150, and/or other component of the EDCS 100 to access a particular set of data from the client 140, BCS server 102, database server 150, and/or other component of the EDCS 100 (whether illustrated or not). Once a particular client application 146 is launched, a user may interactively process a task, event, or other information associated with the client 140, BCS server 102, database server 150, and/or other client 140.

Further, although illustrated as a single client application 146, the client application 146 may be implemented as multiple client applications in the client 140. In some implementations, the client application 146 may act as a GUI interface for the BCS application 108, BCS reporting accelerator 158 (described below), and/or other components (whether illustrated or not) of the EDCS 100.

The interface 149 is used by the client 140 for communicating with other computing systems within the EDCS 100, using network 130. For example, the client 140 can use the interface 149 to communicate with the BCS server 102, database server 150, other clients 140 and/or other systems (whether illustrated or not) that can be communicably coupled to the network 130. The interface 149 may be consistent with the above-described interface 104 of the BCS server 102 or other interfaces (whether illustrated or not) within the EDCS 100. The processor 144 may be consistent with the above-described processor 105 of the BCS server 102 or other processors (whether illustrated or not) within the EDCS 100. Specifically, the processor 144 executes instructions and manipulates data to perform the operations of the client 140, including the functionality required to send requests to the BCS server 102 and/or database server 150, and to receive and process responses from the BCS server 102 and/or database server 150. The memory 148 typically stores objects and/or data associated with the purposes of the client 140 but may also be consistent with the above-described memory 106 of the BCS server 102 or other memories (whether or not illustrated) within the EDCS 100, and can be used to store data similar to that stored in the other memories of the EDCS 100 for purposes such as backup, caching, and the like.

Further, the illustrated client 140 includes a GUI 142. The GUI 142 interfaces with at least a portion of the EDCS 100 for any suitable purpose, including generating a visual representation of a web browser and/or other GUI interface. The GUI 142 may be used to view and navigate among various web pages and/or data located both internally and externally to the client 140, BCS server 102, database server 150 and/or other components of the EDCS 100 (whether illustrated or not) or for any other suitable purpose. For example, in particular, the GUI 142 may be used in conjunction with content from BCS server 102, database server 150, and/or the client 140 to provide enhanced business consolidation system reporting functionality.

There may be any number of clients 140 associated with, or external to, the EDCS 100. For example, while the illustrated EDCS 100 includes one client 140 communicably coupled to the BCS server 102 and database server 150 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, server, or any other suitable processing device. For example, the client 140 may comprise a computer that includes an input device, such as a keypad, touch screen, or other device that can accept user information, and an output device that conveys information associated with the operation of the BCS server 102, database server 150, and/or the client 140 itself, including digital data, visual and/or audio information, or a GUI 142, as shown with respect to the client 140.

In some implementations, any and/or all components of the client 140, both hardware and/or software, may interface with each other and/or the interface using an application programming interface (API) and/or a service layer (neither illustrated). The API may include specifications for routines, data structures, and object classes. The API may be either computer-language independent or dependent and refer to a complete interface, a single function, or even a set of APIs. The service layer provides software services to the EDCS 100. The functionality of the client 140 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. The API and/or service layer can be wholly or partial integral or stand alone in relation to the client 140 or components of the EDCS 100. Moreover, any or all parts of the API and/or the service layer may be implemented as child or sub-modules of another software module, enterprise application, or hardware module.

At a high level, the database server 150 is an electronic computing device within the EDCS 100 that is operable to receive, transmit, process, store, or manage data and information using a relational database. According to some implementations, the database server 150 may be, include, and/or be communicably coupled with an e-mail server, a web server, a caching server, a streaming data server, and/or other suitable server. The database server 150 may operate in a cloud-based computing environment.

In general, the database server 150 is a server that stores and/or executes one or more BCS reporting accelerators 158 responsive to requests/responses sent by an BCS server 102, client 140, other database server 150 and/or other component (whether illustrated or not) within and communicably coupled to the illustrated EDCS 100. The database server 150 provides support for enhanced business consolidation system reporting functionality. In some implementations, database server 150 can be accessed directly or using the network 130 to perform programmed tasks or operations of a particular BCS reporting accelerator 158 and/or associated component (whether illustrated or not). Requests/responses may also be sent to the database server 150 from internal users, external or third-parties, other automated applications, as well as any other appropriate entities, individuals, systems, or computers (whether illustrated or not).

In some implementations, any and/or all components of the database server 150, both hardware and/or software, may interface with each other and/or the interface using an application programming interface (API) 160 and/or a service layer (not illustrated). The API 160 may include specifications for routines, data structures, and object classes. The API 160 may be either computer-language independent or dependent and refer to a complete interface, a single function, or even a set of APIs 160. The service layer provides software services to the EDCS 100. The functionality of the database server 150 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. The API 160 and/or service layer can be wholly or partial integral or stand alone in relation to the database server 150 or components of the EDCS 100. Moreover, any or all parts of the API 160 and/or the service layer may be implemented as child or sub-modules of another software module, enterprise application, or hardware module. Although API 160 is illustrated as integral to the BCS reporting accelerator 158, in some implementations, the API 160 can be stand-alone in relation to the BCS reporting accelerator 158 or even the database server 150.

The database server 150 includes an interface 152. Although illustrated as a single interface 152 in FIG. 1, two or more interfaces 152 may be used according to particular needs, desires, or particular implementations of the EDCS 100. The interface 152 is used by the database server 150 for communicating with other systems in a distributed environment—including within the EDCS 100—connected to the network 130; for example, the client 140, BCS server 102, other database servers 150, and/or other systems (whether illustrated or not) that may be communicably coupled to the network 130. Generally, the interface 152 comprises logic encoded in software and/or hardware in a suitable combination and operable to communicate with the network 130. More specifically, the interface 152 may comprise software supporting one or more communication protocols associated with communications such that the network 130 or interface's hardware is operable to communicate physical signals within and outside of the illustrated EDCS 100.

The database server 150 includes a processor 154. Although illustrated as a single processor 154 in FIG. 1, two or more processors may be used according to particular needs, desires, or particular implementations of the EDCS 100. The processor 154 executes instructions and manipulates data to perform the operations of the database server 150 and/or functionality required to provide enhanced BCS reporting functionality.

The database server 150 also includes a relational in-memory database 156. The in-memory database 156 can, in some implementations, hold data for the database server 150, client 140, BCS server 102, and/or other components of the EDCS 100 (whether illustrated or not). The in-memory database 156 is a high-performance relational database management system (RDBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations, for near-real-time aggregation, replication, synchronization, and processing of data. In some implementations, a persistency layer ensures that a copy of the in-memory database is maintained on non-volatile magnetic, optical, removable, or other suitable non-electronic memory in the event of a power or other system failure in order to allow recovery of the in-memory database. In some implementations, the in-memory database 156 can be replicated to one or more conventional databases (not illustrated) for backup purposes. In some implementations, data from the conventional database can be replicated to and used from the in-memory database 156.

Although illustrated as a single in-memory database 156 in FIG. 1, two or more in-memory databases 156 may be used according to particular needs, desires, or particular implementations of the EDCS 100. While the in-memory database 156 is illustrated as an integral component of the database server 150, in alternative implementations, in-memory database 156 can be external to the database server 150 and/or the EDCS 100. In some implementations, the in-memory database 156 includes one or more calculation views 162, each with associated BCS reporting logic 164, and a factor table 166.

The calculation view 162 is an in-memory database 156 script-based column view that is visible to reporting and other tools. When the calculation view 162 is accessed a function (e.g., the BCS reporting logic 164) is implicitly executed. In some implementations, the calculation view 162 is read-only from generation, while in others, the calculation view 162 can be dynamically modified post-generation.

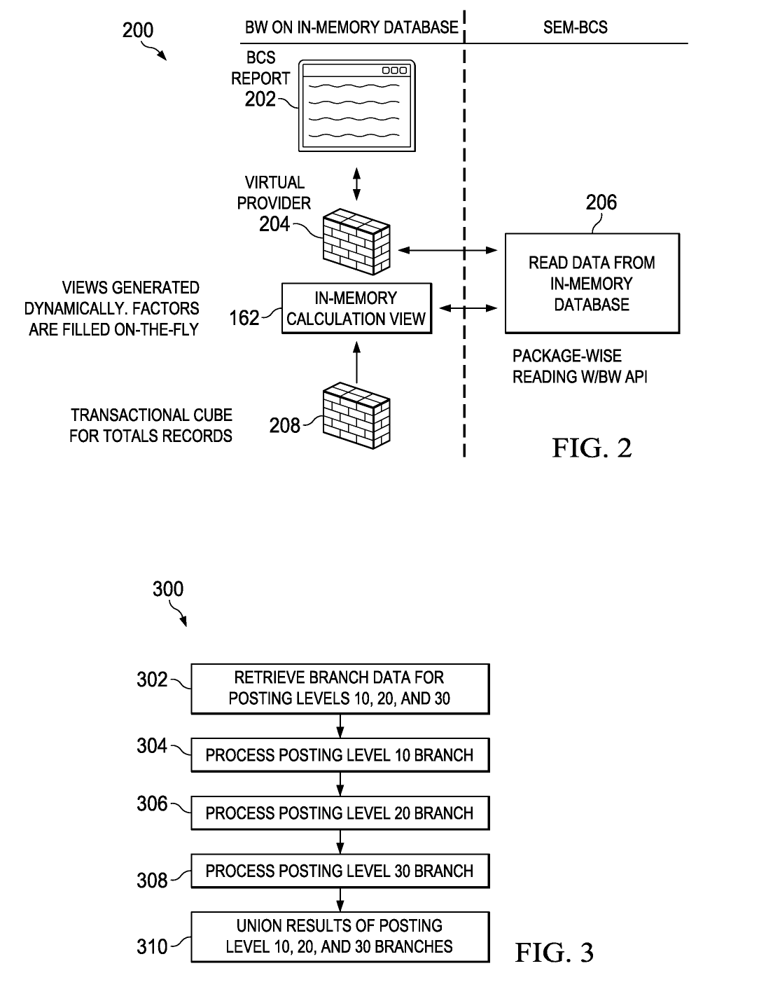

The calculation view 162 stores BCS reporting logic 164 and is generated dynamically based upon a particular query and during runtime of the particular query. For example, the BCS reporting logic 164 structure/model of the calculation view 162 is determined by a particular transaction cube/total record (not illustrated in FIG. 1—described below with FIG. 2) and a reporting mode associated with the particular query (e.g., reporting modes include standard, restatement, purchase, etc.). Queries are parsed by the BW. Query-related information, such as selection conditions as well as required fields, is passed from the BW to the BCS. In the preparation phase for BCS reporting logic 164, the system checks whether or not the field “consolidation group” is included into the BW query. If not, the BCS reporting logic 164 will be skipped. In the BCS reporting accelerator 158, the output of the preparation phase is a factor table. BCS reporting accelerator 158 will create a copy of the factor table in the in-memory database 156 and make factor information available for calculation views. This is referred to as a “push down” into the in-memory database 156.

Each query contains at least a field “consolidation group” that must be restricted in order to invoke reporting logic at the database server 150. By default, reporting mode “standard” is used, unless the field “Reporting Mode” is explicitly restricted to other modes such as “Restatement.” The calculation view is also generated only once for a given transactional cube and reporting mode. The BCS allows customers to set up different models for their transactional cubes, where transactional data is stored. In other words, transactional cubes can have different fields in each different customer system. The transactional cube is the input for the calculation views. Therefore, calculation views must be generated for a new transactional cube. Company hierarchies are physically stored in the BW. The same hierarchy in the BW can be structured differently for a different time period. For example, a company can be sold from one group to another from time to time. The company hierarchy is also evaluated differently under various reporting modes. In reporting mode ‘S’ (standard), the BCS takes the posting period in each record to decide the correct hierarchy. In the correct hierarchy, the BCS takes the determined business group that the company belongs to and fills it into the current record. However, in reporting mode ‘R’ (restatement), additional fields REFYEAR+REFPERIOD (reference year and reference period, respectively) have to be specified in the query to decide which hierarchy is applicable for the company. In other words, reporting logic depends on the reporting mode specified in the query. The calculation logic in the calculation views 162 is different under the different reporting modes. This is why the calculation view is generated for different reporting modes (and with a given transactional cube and reporting mode, the calculation view is generated only once.)

The high-performance provided by the in-memory database 156 allows the BCS reporting logic 164 executed as part of the calculation view 162 and using data supplied by one or more queries to supply business consolidation reporting result data in real- or substantially-near real-time. For example, when an accountant in a company enters transactions into an enterprise resource planning system, the accountant does not care about which business group their company belongs to. This is because the transactions are only related to the accountant's company itself. If the company is transferred from one sub-group of a business group to another, the data still only applies to the particular company. For the same reason, the records of intercompany eliminations do not depend on the group. Only at the time of reporting, will the BCS (in general) determine the correct group for every transactional record, according to the current hierarchy at that time. The group information will be updated by the BCS reporting logic 164 for a generated CFR and written physically into database. Result data from the calculation view 162 can be accessed by one or more components of the EDCS 100 using the API 160 and/or service layer associated with the BCS reporting accelerator 158. The high-performance nature of the in-memory database 156 also makes the use of a separate storage/reporting cube unnecessary as well as pre-calculated results/data.

The in memory database also stores one or more instances of a factor table 166. The factor table 166 is written into the in-memory database 156 tables by a suitable component of the EDCS 100, for example the BCS application 108, and contains data related to the structure/hierarchy of a particular business group, applicable reporting time period, etc. For example, the factor table 166 could store that a business group contains three subsidiaries, their base countries, currencies, inter-subsidiary transactions, agreements, and business arrangements, a six-month reporting period, and other suitable data. The factor table 166 can be used by the BCS reporting accelerator 158, calculation view 162, and/or other suitable component of the EDCS 100 to interpret transactional data in order to generate a CFR. The company-business group relationship depends on an associated company/business group hierarchy present at a particular time. For example, a company can belong to different business groups in a fiscal period, but at the time of a requested CFR, it will have a particular hierarchical relationship which is associated with the factor table 166. The BCS reporting logic 164 will check data against the data in the factor table 166 to determine correct group information for the data. As this calculation is normally a time-intensive process, the BCS reporting logic 164 is pushed to the in-memory database 156 calculation view 162 to increase processing speed.

The BCS reporting accelerator 158 is any application that serves as the calculation engine for BCS reports as well as to determine/generate appropriate calculation views 162/BCS reporting logic 164 for particular data as specified by a reporting query (e.g., using one or more factor, etc.). The BCS reporting accelerator 158 is associated with one or more APIs 160 that can be used by one or more components of the EDCS 100 (e.g., the client application 146 using the BCS application 108) to request a CFR. In some implementations, the BCS reporting accelerator 158 performs three functions: 1) generation of calculation views 162, 2) pushing down the content of the factor table 166 (as described above), and 3) calculation of a correct group for data with both the calculation view 162 and the factor table 166. Although shown as a separate entity within the database server 150, in some implementations, the described BCS reporting accelerator 158/API 160 can be considered to be and/or combined with the BCS reporting logic 164.

FIG. 2 is a block diagram illustrating an example solution architecture 200 for providing enhanced BCS reporting functionality according to an implementation. The example solution architecture 200, is split into two aspects, 1) the business warehouse (BW) on the database server 150/in-memory database 156 and 2) strategic enterprise management (SEM)-BCS functionality associated with the BCS server 102.

As shown, a BCS report 202 (e.g., CFR as described above) is generated on the database server 150/in-memory database 150 (and/or other associated components). In some implementations, the BCS report 202 is generated wholly by the BCS reporting accelerator 158 (and/or other associated components). In other implementations, the BCS reporting accelerator 158 can process and pass BCS report data to the BCS application 108 (e.g., using API 160/proxy 109) for processing, generation, and/or formatting of the BCS report 202.

The virtual provider 204 acts as an interface/proxy to the in-memory database data as well as a function module. The virtual provider 204 is modeled as a “cube” (i.e., a join of database tables in the in-memory database 156) and does not store its own data. The virtual provider 204 can be called by other applications, cubes, etc. and can process/change data before passing it to the calling application, cube, etc. For example, in the example solution architecture 200, the virtual provider 204 is called by the SEM-BCS (e.g., the client application 146, application BCS application 108, and/or associated components) to read data from the in-memory database (206). The data is read from an in-memory database calculation view 162 using package-wise reading with a BW API (e.g., API 160) through the BCS reporting accelerator 158.

The calculation view 162 is generated dynamically (e.g., by the BCS reporting accelerator 158) and factor from the factor table 166 are filled/applied on the fly to return BCS report 202 data. Factors are one or more data points use to specify/filter requested data during generation of a BCS report 202. For example, if a BCS report 202 query is received for a business group containing subsidiaries A, B, and C, the factor of A, B, and C can be used to “filter” the available in-memory database 156 data (e.g., a transaction cube 208 containing all the root data available in the in-memory database—also referred to as “total record”) in order to limit data processed to data satisfying the appropriate factors. In one instance, the factors of subsidiaries A/B/C and the reporting time period (among other things) can be parsed from a query and inserted into the factor table 166 and accessed from the factor table 166 in order to limit/filter the data available in the transaction cube 208. In some instances, additional factors can be generated based on factor table 166 and/or any suitable data.

FIG. 3 is a flow chart illustrating a method 300 for generating a calculation view providing enhanced business consolidation system reporting functionality according to an implementation. For clarity of presentation, the description that follows generally describes method 300 in the context of FIGS. 1-2. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, or in any order. In some implementations, the method 300 is run as/part of reporting logic 164 as illustrated in FIG. 1.

A “posting level” classifies financial journal entry data in the BCS. In some implementations, posting levels distinguish between the following types of financial journal entries (among others): adjustments to reported financial data, standardizing entries, entries for inter-unit elimination and the elimination of inter-unit profit/loss in transferred inventory, consolidation group-dependent entries, and consolidation-group-specific entries. There is also a separate posting level for reported financial data.

A document type is typically assigned to journal entries. The document type determines the posting level of the entry. When reported financial data is collected, the BCS uses a separate posting level; however, the BCS does not post any documents.

When entries are posted, the BCS writes the posting level to the totals record and to the journal entry. Among other things, the classification of journal entries with posting levels serves as an aid for selecting data by posting level. By specifying posting levels when selecting data, individual steps of a consolidation process can be evaluated/reflected in a CFR. The BCS also uses posting level values for internal consistency checks of data and/or for the selection of data to be processed.

In some implementations, available posting levels are predefined in the BCS. For example, a predefined set of posting levels could include:

### Posting Level Use

00 Reported financial data
No postings with documents exist for reported financial data.

01 Adjustments to reported financial data
If, after collecting the reported data of consolidation units, central changes are desired to the data. Post adjustment entries with posting level 01 (posting also documents changes).

02 Reported data: consolidation group changes
(See explanations below.)

10 Standardizing entries
Standardize the reported data of consolidation units to comply with corporate policies or valuation rules. In data records with posting levels less than or equal to 10, only the consolidation unit is recorded into the data records—not to the consolidation group. Reporting takes into account the data records for all consolidation groups.

12 Standardizing entries: consolidation group changes
(See explanations below.)

20 Two-sided elimination entries
Inter-unit elimination, the elimination of inter-unit profit/loss in inventory, and reclassification are examples of two-sided elimination entries. Here, both the consolidation unit and the partner unit are recorded in the data records. Reporting takes into account the data records for all consolidation groups in which both the consolidation unit and the partner unit are posted.

22 Two-sided elimination entries: consolidation group changes
(See explanations below.)

30 Consolidation group-dependent entries
The consolidation unit, partner unit, and consolidation group are recorded in the data records for consolidation of investments entries, and in the entries for elimination of inter-unit profit/loss in transferred inventory that have this posting level. Reporting only takes into account the data records with the assigned consolidation group and the higher-level consolidation groups.

32 Consolidation group-dependent entries: consolidation group changes
(See explanations below.)

35 Consolidation-group-specific entries
Posting level 35 can be used to make group-specific manual postings that relate to management consolidation only and are not included in external consolidation.

In other implementations, more or less posting levels/uses may be predefined. In some implementations, posting levels can be created, deleted, and/or edited. In the case of creating, deleting, and/or editing, appropriate tools/applications can be provided/executed to convert/translate posting level value(s) to other posting level value(s).

In generating a CFR, data is typically classified into three selectable posting level categories:

Single Company Closing Records (Posting Level 10). This type of record relates to single company transactions and is marked for a posting level equal to or less than 10 (e.g., posting level 00, 01, 02 are treated as posting level 10).

Inter-Company Elimination Records (Posting Level 20). This type of record relates to transactions between two subsidiaries of a business group, etc. and is marked as for a posting level equal to or less than 20 but greater than 10.

Group-Dependent Elimination Records (Posting Level 30). This type of record relates to business group/company hierarchy transactions and is marked for a posting level equal to or less than 30 but greater than 20.

The following is an example of data entries in different posting levels (A and B are trading partner companies):

| | | | Posting | | |
|---|---|---|---|---|---|
| Company | Partner | Account | Level | Amount | Remarks |
| A | B | Account | 10 | 100 | Transaction data |
| | | Receivable | | | |
| B | A | Account | 10 | −100 | Transaction data |
| | | Payable | | | |
| A | B | Account | 20 | −100 | Eliminations |
| | | Receivable | | | generated by BCS |
| B | A | Account | 20 | 100 | Eliminations |
| | | Payable | | | generated by BCS |

In another example of data entries in different posting levels, A can be considered an investor (parent) of B, with an investment share of 80%. A & B together are considered GROUP1.

| | | | | Posting | | |
|---|---|---|---|---|---|---|
| Company | Partner | Group | Account | Level | Amount | Remarks |
| A | B | | Investment | 10 | 800 | Transaction data |
| B | | | Common | 10 | −1000 | Transaction data |
| | | | Stock | | | |
| A | B | GROUP1 | Investment | 30 | −800 | Eliminations |
| | | | | | | generated by BCS |
| B | | GROUP1 | Common | 30 | 1000 | Eliminations |
| | | | Stock | | | generated by BCS |
| B | | GROUP1 | Minority stock | 30 | −200 | Eliminations |
| | | | | | | generated by BCS |

Data of posting level 10/20 is group independent. Often the data in posting level 10/20 can be transferred from one group to another from time to time and group affiliation needs to be accounted for based on a particular requested reporting period. Proper group identification needs to be applied to make posting level 10/20 group dependent and appear under a correct group in a CFR/BCS report 202.

At 302, data for posting levels 10, 20, and 30 is retrieved from a calculation cube/total record. From 302, method 300 proceeds to 304.

At 304, for a posting level 10 branch, the total record is joined with a factor table specifying particular factors related to a reporting query for a consolidation unit by the consolidation unit. For example, for a transactional record <company1, June, $100> and two records in factor tables: <company1, group1, June> & <company1, group2, July>, after a JOIN operation of these two tables, one record is created: <company, group1, June, $100>. This is a representative example of the functionality of reporting logic in a calculation view for reporting mode standard (‘S’). When two tables are JOINed, keys are provided. In this example, the keys are company and period. As previously mentioned, a factor table 166 is generated during the preparation phase of BCS reporting logic 164. The BCS reporting accelerator 158 creates a copy of it in the in-memory database for calculation views 162. For example, when an accountant in a company enters transactions into an enterprise resource planning system, the accountant does not care about which business group their company belongs to. This is because the transactions are only related to the accountant's company itself. If the company is transferred from one sub-group of a business group to another, the data still only applies to the particular company. For the same reason, the records of intercompany eliminations do not depend on the group. This explains why the group information is not filled in transaction data with posting level 10 and 20 before BCS reporting logic 158 comes into play. Only at the time of reporting, will the BCS (in general) determine the correct group for every transactional record, according to the current hierarchy at that time. The group information will be updated by the BCS reporting logic 164 for a generated CFR. From 304, method 300 proceeds to 306.

At 306, for a posting level 20 branch, firstly, join the total record with a factor table of a consolidation unit by the consolidation unit. Secondly, join the result with the factor table of the consolidation unit again by a partner unit. Thirdly, check if a consolidation group and the partner group are the same and filter on it. For example, for an example hierarchy similar to: group1→group2, consider a company1 to be under group1 and company2 to be under group2. Further assume one transactional record <company1, company2, June, $100>. Here company2 is the partner company of company1. There are also records in factor tables: <company1, group1, June>, <company2, group2, June> & <company2, group1, June>. Here there are two factor records for company2, because logically it belongs to group1 as well as group2. After a JOIN operation of the two tables, the result is a record <company1, company2, group1, June, $100>. This means that the transaction record is considered to belong only to group1, because only group1 is the common group that both company1 and company2 belong to. As another example, when an accountant in a company enters transactions into an enterprise resource planning system, the accountant does not care about which business group their company belongs to. This is because the transactions are only related to the accountant's company itself. If the company is transferred from one sub-group of a business group to another, the data still only applies to the particular company. For the same reason, the records of intercompany eliminations do not depend on the group. Only at the time of reporting, will the BCS (in general) determine the correct group for every transactional record, according to the current hierarchy at that time. The group information will be updated by the BCS reporting logic 164 for a generated CFR and written physically into database.

An example of an intercompany elimination result (in posting level 20) in the BCS could include:

| | | Business | | |
|---|---|---|---|---|
| Company | Account | Group (BG) | Posting Level | Amount |
| A | A/R | | 00 | 100 |
| B | A/P | | 00 | −100 |
| A | A/R | | 20 | −100 |
| B | A/P | | 20 | 100 |

As can be seen, no business group (BG) data is present. The BCS determines the group information according to a known company/BG hierarchy, such as:

| | | |
|---|---|---|
| BG1 | | |
| | BG2 | |
| | | A |
| | | B |

Given the illustrated example hierarchy above, the group information will be filled in as BG2.

| | | | | |
|---|---|---|---|---|
| A | A/R | BG2 | 00 | 100 |
| B | A/P | BG2 | 00 | −100 |
| A | A/R | BG2 | 20 | −100 |
| B | A/P | BG2 | 20 | 100 |

At 308, for a posting level 30 branch, join the total record with the factor table of a consolidation group by a consolidation unit and the consolidation group together. For example, given a transactional record <company1, group1, June, $100> (in posting level 30) and two records in factor tables: <company1, group1, June> & <company1, group2, July>, after a JOIN operation of the two tables, the record <company, group1, June, $100> is produced. From 308, method 308 proceeds to 310.

For posting level 30 data, group information is associated with each record. There is no need to calculate group information in reporting logic for these records. For example:

| | | Business | | |
|---|---|---|---|---|
| Company | Account | Group (BG) | Posting Level | Amount |
| A | Investment | CG2 | 30 | −100 |
| B | Equity | CG2 | 30 | 100 |

At 310, a union is performed on the three results to get a final result. From 310, method 300 stops.

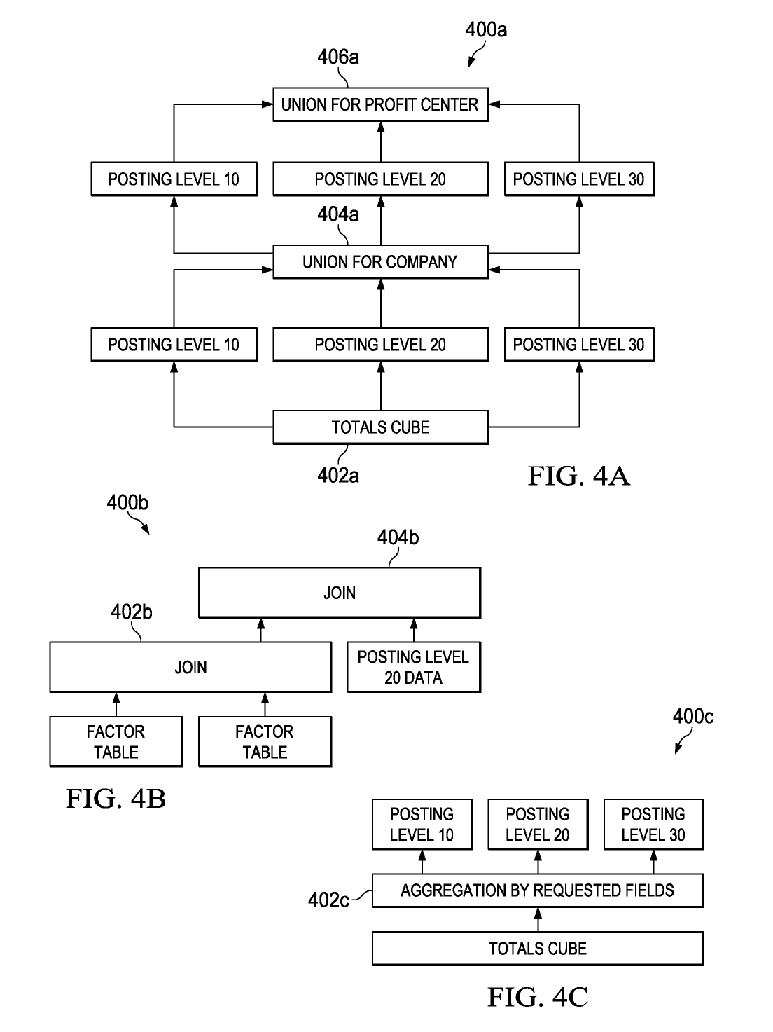

FIGS. 4A-4C illustrate example method enhancements 400a-400c to portions of the method 300 of FIG. 3. For clarity of presentation, the description that follows generally describe methods 400a-400c in the context of FIGS. 1-3. However, it will be understood that methods 400a-400c may be performed, for example, by any other suitable system, environment, software, and hardware, or a combination of systems, environments, software, and hardware as appropriate. In some implementations, various steps of methods 400a-400c can be run in parallel, in combination, in loops, or in any order. Note that the example methods 400a-400c are applied to generate a single-level consolidation unit model using consolidation units as company and profit center. Those of skill in the art will appreciate that this is only an exemplary application of the concepts presented in the disclosure. The presented examples are not meant to be limiting in any way.

FIG. 4A illustrates generating multiple level models used to generate the calculation view. For example, for FIG. 4A, in each posting level 10/20/30 branch, a factor table for a company is joined with the total record and then joined with a factor table for a profit center. In the illustrated enhancement, a company level model 404a is generated first and treated as a new “totals cube” 402a. The company level model 404a has generation code applied against it again to then generate a profit center model 406a that is used as the calculation view. It is important to note that multiple consolidation units can be iteratively used to generate a precise calculation view.

FIG. 4B illustrates an enhancement to “posting level 20” logic for performance optimization. Here a join 402b is performed on factor tables for each “consolidation” unit (e.g., consolidation unit/partner unit). This provides all possible consolidation units into one consolidation group. Then the consolidation group is joined with the posting level 20 data of the totals record. The result 404b contains all the total record data in which the consolidation unit and partner unit are in the same group.

FIG. 4C illustrates an enhancement to reduce data volume. Here, because all fields of the total record are not needed in final reporting aggregation/filtering 402c is performed on the totals cube by appropriate fields needed for reporting. For example, a received CFR/BCS report 202 request query can be parsed to determine appropriate fields needed for reporting purposes. These fields can be used to minimize the volume of data that needs to be “handled” by various components of the EDCS 100 (e.g., the BCS reporting accelerator 158, calculation view 162, and/or BCS reporting logic 164). The reduction in data volume helps to increase processing/reporting efficiency, speed, etc.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU, including single-thread or multi-threaded CPUs. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an GS, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
retrieving financial journal entry data from a total record for consolidation into a consolidated financial report, the financial journal entry data classified as single company closing records, inter-company elimination records, and group-dependent elimination records;
processing the single company closing records resulting in single company closing records result data;
processing the inter-company elimination records resulting in inter-company elimination records result data;
processing the group-dependent elimination records resulting in group-dependent elimination records result data;
performing, by operation of a computer, a union of the single company closing records result data, the inter-company elimination records result data, and the group-dependent elimination records result data to generate consolidated financial report data; and
generating a consolidated financial report based, at least in part, on the consolidated financial report data.

2. The method of claim 1, wherein processing the single company closing records comprises, joining the total record with a factor table for a consolidation unit by the consolidation unit.

3. The method of claim 1, wherein processing the inter-company elimination records comprises:
joining the total record with a factor table of a consolidation unit by the consolidation unit to generate a first result;
joining the first result with the factor table of a consolidation group by a partner unit;
checking if the consolidation group and the partner group are the same to generate a check result; and
filtering on the check result.

4. The method of claim 1, wherein processing the group-dependent elimination records comprises joining the total record with a factor table of a consolidation group by a consolidation unit and the consolidation group.

5. The method of claim 1, wherein, for each of the single company closing records, inter-company elimination records, and group-dependent elimination records:
joining a factor table for a company with the total record to form a first result; and
joining a factor table for a profit center with the first result to form a second result.

6. The method of claim 1, wherein processing the inter-company elimination records comprises:
joining factor tables for consolidation units to form a first result; and
joining the first result with the inter-company elimination records of the total record.

7. The method of claim 1, wherein data from the total record is aggregated according to required fields prior to processing each of the single company closing records, inter-company elimination records, and group-dependent elimination records.

8. A non-transitory, computer-readable medium storing computer-readable instructions executable by a computer to:
retrieve financial journal entry data from a total record for consolidation into a consolidated financial report, the financial journal entry data classified as single company closing records, inter-company elimination records, and group-dependent elimination records;
process the single company closing records resulting in single company closing records result data;
process the inter-company elimination records resulting in inter-company elimination records result data;
process the group-dependent elimination records resulting in group-dependent elimination records result data;
perform a union of the single company closing records result data, the inter-company elimination records result data, and the group-dependent elimination records result data to generate consolidated financial report data; and
generate a consolidated financial report based, at least in part, on the consolidated financial report data.

9. The medium of claim 8, wherein processing the single company closing records comprises instructions executable to join the total record with a factor table for a consolidation unit by the consolidation unit.

10. The medium of claim 8, wherein processing the inter-company elimination records comprises instructions executable to:
join the total record with a factor table of a consolidation unit by the consolidation unit to generate a first result;
join the first result with the factor table of a consolidation group by a partner unit;
check if the consolidation group and the partner group are the same to generate a check result; and
filter on the check result.

11. The medium of claim 8, wherein processing the group-dependent elimination records comprises instructions executable to join the total record with a factor table of a consolidation group by a consolidation unit and the consolidation group.

12. The medium of claim 8, comprising instructions, for each of the single company closing records, inter-company elimination records, and group-dependent elimination records, executable to:
join a factor table for a company with the total record to form a first result; and
join a factor table for a profit center with the first result to form a second result.

13. The medium of claim 8, wherein processing the inter-company elimination records comprises instructions executable to:
join factor tables for consolidation units to form a first result; and
join the first result with the inter-company elimination records of the total record.

14. The medium of claim 8, wherein data from the total record is aggregated according to required fields prior to processing each of the single company closing records, inter-company elimination records, and group-dependent elimination records.

15. A computer-implemented system comprising:
a memory configured to hold a total record;
a processor interoperably coupled with the memory and configured to perform operations comprising:
retrieve financial journal entry data from a total record for consolidation into a consolidated financial report, the financial journal entry data classified as single company closing records, inter-company elimination records, and group-dependent elimination records;
process the single company closing records resulting in single company closing records result data;
process the inter-company elimination records resulting in inter-company elimination records result data;
process the group-dependent elimination records resulting in group-dependent elimination records result data;
perform a union of the single company closing records result data, the inter-company elimination records result data, and the group-dependent elimination records result data to generate consolidated financial report data; and
generate a consolidated financial report based, at least in part, on the consolidated financial report data.

16. The system of claim 15, wherein processing the single company closing records is configured to join the total record with a factor table for a consolidation unit by the consolidation unit.

17. The system of claim 15, wherein processing the group-dependent elimination records is configured to:
join the total record with a factor table of a consolidation unit by the consolidation unit to generate a first result;
join the first result with the factor table of a consolidation group by a partner unit;
check if the consolidation group and the partner group are the same to generate a check result; and
filter on the check result.

18. The system of claim 15, wherein processing the group-dependent elimination records is configured to join the total record with a factor table of a consolidation group by a consolidation unit and the consolidation group.

19. The system of claim 15, further configured, for each of the single company closing records, inter-company elimination records, and group-dependent elimination records, to:
join a factor table for a company with the total record to form a first result; and
join a factor table for a profit center with the first result to form a second result.

20. The system of claim 15, wherein processing the inter-company elimination records is configured to:
join factor tables for consolidation units to form a first result; and
join the first result with the inter-company elimination records of the total record.

21. The system of claim 15, wherein data from the total record is aggregated according to required fields prior to processing each of the single company closing records, inter-company elimination records, and group-dependent elimination records.

22. A computer-implemented method comprising:
retrieving financial journal entry data from a total record for consolidation into a consolidated financial report, the financial journal entry data classified as single company closing records, inter-company elimination records, and group-dependent elimination records;
aggregating data from the total record according to required fields prior to processing each of the single company closing records, inter-company elimination records, and group-dependent elimination records;
processing the single company closing records resulting in single company closing records result data, the processing comprising, joining the total record with a factor table for a consolidation unit by the consolidation unit;
processing the inter-company elimination records resulting in inter-company elimination records result data, the processing comprising:
joining the total record with a factor table of a consolidation unit by the consolidation unit to generate a first result;
joining the first result with the factor table of a consolidation group by a partner unit;
checking if the consolidation group and the partner group are the same to generate a check result; and
filtering on the check result;
processing the group-dependent elimination records resulting in group-dependent elimination records result data, the processing comprising joining the total record with a factor table of a consolidation group by a consolidation unit and the consolidation group;
performing, by operation of a computer, a union of the single company closing records result data, the inter-company elimination records result data, and the group-dependent elimination records result data to generate consolidated financial report data; and
generating a consolidated financial report based, at least in part, on the consolidated financial report data.
